(19) United States
(12) Patent Application Publication
(10) Pub. No.: US 2015/0160629 A1
(43) Pub. Date: Jun. 11, 2015

(54) SYSTEMS AND METHODS FOR INITIATING PREDETERMINED SOFTWARE FUNCTION FOR A COMPUTING DEVICE BASED ON ORIENTATION AND MOVEMENT

(71) Applicant: Toshiba Global Commerce Solutions Holdings Corporation, Tokyo (JP)

(72) Inventors: J. David Landers, JR., Raleigh, NC (US); David Steiner, Raleigh, NC (US); Paul Wilson, Cary, NC (US); Kimberly Wood, Raleigh, NC (US)

(21) Appl. No.: 14/164,917

(22) Filed: Jan. 27, 2014

Related U.S. Application Data
(60) Provisional application No. 61/914,382, filed on Dec. 10, 2013.

(51) Int. Cl. G05B 15/02

(52) U.S. Cl. CPC G05B 15/02

(57) ABSTRACT

Systems and methods for initiating predetermined software function for a computing device based on orientation and movement are disclosed. According to an aspect, a method comprises detecting a change in movement of a computing device to substantially zero velocity for a predetermined period of time. The method further detects a predetermined orientation of the computing device. The method further initiates a predetermined operation of the computing device in response to detecting the decrease in movement for the predetermined period of time and detecting the predetermined orientation of the computing device.

### CROSS REFERENCE TO RELATED APPLICATION

This application claims the benefit of U.S. Provisional Patent Application No. 61/914,382, filed Dec. 10, 2013 and titled SYSTEMS AND METHODS FOR AUTOMATIC SOFTWARE FUNCTION FOR A COMPUTING DEVICE BASED ON ORIENTATION AND MOVEMENT, the content of which is hereby incorporated herein by reference in its entirety.

### TECHNICAL FIELD

The present invention relates to retail devices and equipment, and more specifically, systems and methods for initiating predetermined software function for computing devices based on orientation and movement.

### BACKGROUND

In retail environments, such as grocery stores and other “brick and mortar” stores, retail personnel interact with customers, products, or other objects located in the environment. As an example, retail personnel may carry a mobile computing device, such as a tablet computer, configured with retail sales functionality for conducting sales transactions, conducting inventory tasks, and the like. Current mobile computing devices (e.g., an iPAD® device, ANDROID™ or WINDOWS® tablet computers) have virtual touchscreen keyboards that allow the user to swipe or press a button to bring the virtual keyboard to the screen for an application that requires keyboard or screen input. The use of mobile computing devices allow the user to roam, thus allowing the user to not be tethered or tied to a single location and bringing the user closer to the customer or customer needs. Typically, the user swipes or presses a button to bring the virtual keyboard to the screen. If the user is carrying a load or their hands are otherwise full the user must generally free their hands for interaction with the mobile computing device. This can be an inconvenience at best or impossible, thus there is a need for devices and techniques that provide a more versatile and mobile oriented solution for retail personnel and users to interact with items and customers in the retail environment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for initiating predetermined software function for a computing device based on orientation and movement. According to an aspect, a method includes detecting a change in movement of a computing device to substantially zero velocity for a predetermined period of time. The method further includes detecting a predetermined orientation of the computing device. The method further includes initiating a predetermined operation of the computing device in response to detecting the decrease in movement for the predetermined period of time and detecting the predetermined orientation of the computing device.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a system for initiating predetermined software function for a computing device based on orientation and movement according to embodiments of the present invention;

FIG. 2 is a flowchart of an example method for automatic software function for a computing device based on orientation and movement; and

FIG. 3 is a flowchart of the example method of FIG. 2 for initiating predetermined software function for a computing device based on orientation and movement with configurable settings in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, WINDOWS® CE, FLEXOS, OS/9, JavaOS, iOS and ANDROID™. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

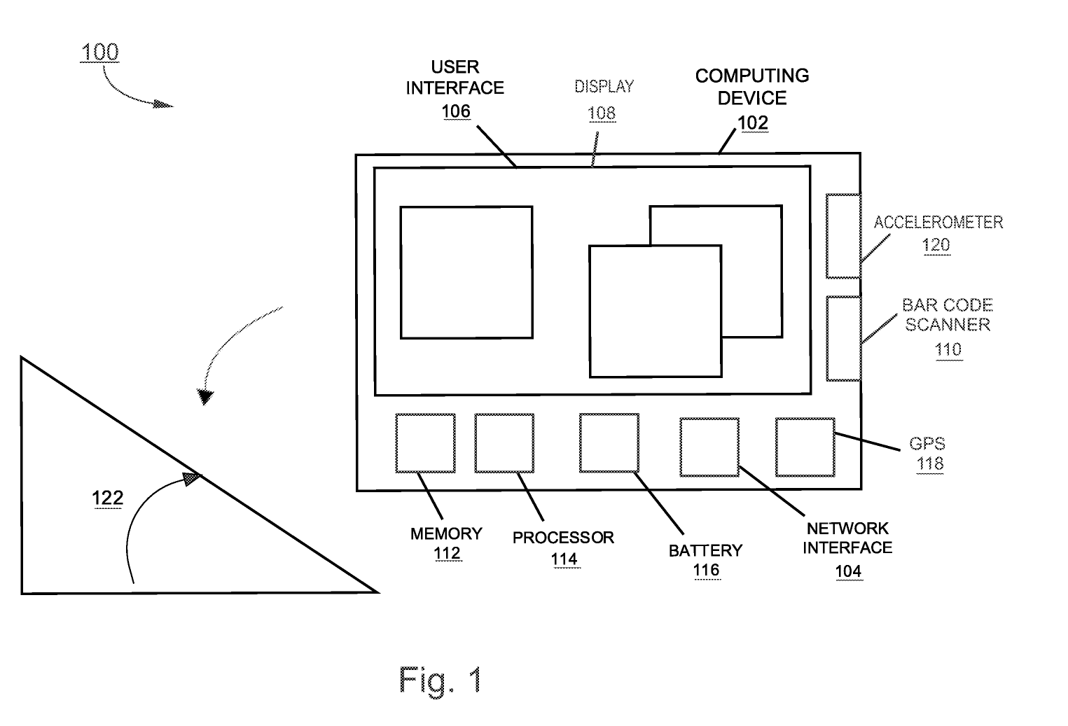

The presently disclosed invention is now described in more detail. For example, FIG. 1 shows a block diagram of a system 100 according to embodiments of the present invention. The system 100 may be implemented in whole or in part in any suitable environment, such as a retail environment. For example, the system 100 may be implemented in a retail store having a variety of products or items for purchase and one or more point of sale (POS) terminals. For example, a computing device 102 may operate as a POS device that can be operated by retail personnel for conducting purchase transactions with customers or for processing products within the retail environment (e.g., inventory of products). The computing device 102 may be communicatively connected via a communications network interface 104 to a network, which may be any suitable local area network (LAN), either wireless (e.g., BLUETOOTH® communication technology) and/or wired. The computing device 102, and other components, not shown, may be configured to acquire data within the retail environment, to process the data, and to communicate the data to a centralized server. For example, the computing device 102 may operate together to implement a retail function and to communicate data related thereto to a server. The server may reside in the retail store or be remotely located.

In continuing reference to FIG. 1, the components of the system 100 may each include hardware, software, firmware, or combinations thereof. For example, software residing in memory of a respective component may include instructions implemented by a processor for carrying out functions disclosed herein. As an example, the computing device 102 may each include a user interface 106 including a display 108 (e.g., a touchscreen display), a barcode scanner 110, and/or other equipment for interfacing with retail personnel and for conducting a purchase transaction for purchase of items by customers. The computing device 102 may also include memory 112, a processor 114, and a battery 116. The computing device 102 may be configured to implement POS or other retail functionality. The computing device 102 may also include the communications network interface 104 for communicating with a network. The computing device 102 may include hardware (e.g., image capture devices, scanners, and the like) for capture of various data within the retail environment. For example, the computing device 102 may include an image capture device (e.g., a camera) for capturing one or more images of a retail item (e.g., a product) and interaction of a user's hand or finger with the item. In another example, the computing device 108 may include a scanner for scanning items for inventory or for POS functions (e.g., customer purchase of a scanned product). Further, the computing device 102 may also include an optional GPS 118 to be used by the computing device 102 to identify the precise location of the computing device 102. Further, the computing device 102 may include an accelerometer 120 to enable the computing device 102 to determine precise orientation of the computing device 102.

In continuing reference to FIG. 1, the computing device 102 is configured to detect a change in movement of the computing device 102 to substantially zero velocity for a predetermined period of time and at a predetermined orientation 122 then, in response, initiate a predetermined operation of the computing device 102. The computing device 102 uses the accelerometer 120 to detect both movement and the non-movement of the computing device 102. Thus, the computing device 102 is able to detect change of movement, speed of movement or the cessation of movement to substantially zero velocity. By using the accelerometer 120 to detect both movement and the non-movement of the computing device 102, the rate of change of velocity may also be detected. As an example, the rate of change of velocity to zero (i.e., deceleration) is detectable. This may be as a result of a tap of the computing device 102 against a counter top in a workspace. The computing device 102 may be at substantially zero velocity by being placed on a counter top in a workspace, on a desk or in a stand oriented at a particular degree of angle, as an example. The computing device 102, using the processor 114, is further configurable to detect a period of time of the movement or the cessation of the movement of the computing device 102. In this manner, the computing device 102 may determine the length of time the computing device 102 has remained at substantially zero velocity. The predetermined period of time is a configurable setting, so as to allow the computing device 102 to determine a variable threshold for the period of time the computing device should remain substantially at zero velocity. Substantially zero velocity is also a configurable parameter, wherein the accelerometer is able to disregard unintended movement, such as, bumping or slippage as an example. As an example, a computing device 102 placed on the counter top in a workspace may get bumped or slightly nudge. If this is a temporary movement defined by no movement beyond a predetermined period of time, the computing device 102 may ignore the bump.

In continuing reference to FIG. 1, the computing device 102 is configured to use the accelerometer and/or an optional GPS 118 to sense movement and orientation 122 of the computing device 102. In this manner, the computing device 102 may determine both the velocity and orientation, using this velocity and orientation data. The computing device 102, using the accelerometer 120 and/or the GPS 118, may use the processor 114 to detect movement over a period of time. If either or both of the velocity and orientation of the computing device 102 meet predetermined thresholds for both movement and period of time, the computing device 102 may be configured to initiate a predetermined operation of the computing device 102. The predetermined operation may be the execution of a set of computer-readable instructions. In this manner, the predetermined operation initiated may include displaying a keyboard on the display 108, displaying a webpage, starting a displayed timer, or another application configured by the user. The thresholds for predetermined movement, orientation, period of time and resulting initiated operation are configurable through the network interface 104, the bar code scanner 114, a user interface displayed on the display 108 or other inputs that may not be shown, such as buttons, switches or dials on the computing device 102. The thresholds for predetermined movement and orientation may be configured by the user via the user interface 106 or automatically by the system 100. As an example, the predetermined movement may be defined as a slowing of the computing device 102 to a velocity of zero (0) or a velocity of substantially zero (0). A velocity of substantially zero (0) is configured by the user or system 100 to be a velocity at which the computing device 102 properly responds to the user's movements. As an example, a user may place the computing device 102 on a counter, wherein the computing device 102 may be caused to bounce slightly, the slight bouncing may be a velocity or rate of deceleration acceptable for the users or retail environment's needs. Additionally, the computing device 102 may be placed on a cart, forklift, or other vehicle that is moving. In this example, the computing device 102 is still moving, therefore the movement of the computing device 102 must be configured to adjust for this movement.

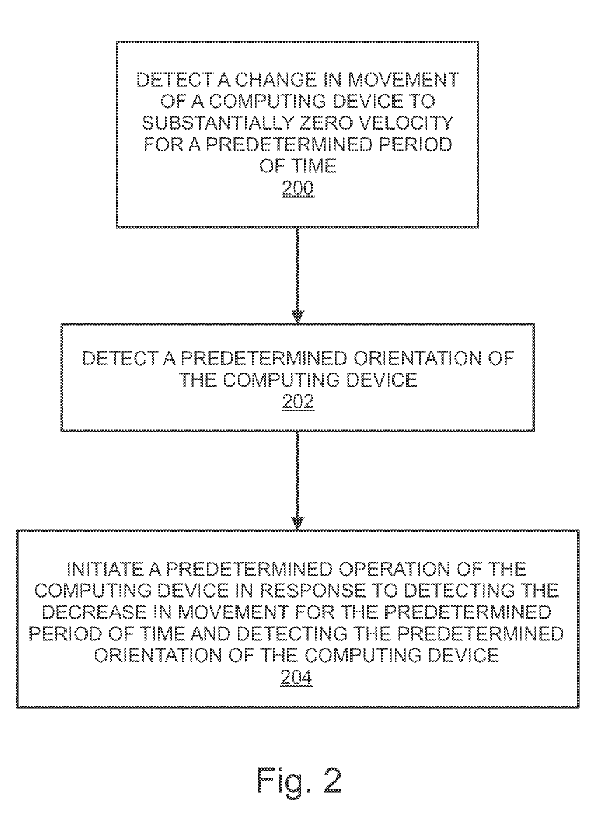

In accordance with embodiments of the present invention, FIG. 2 illustrates a flowchart of an example method for automatic software function for the computing device 102 based on orientation and movement of the computing device 102. The method of FIG. 2 is described as being implemented by the computing device 102, although the method may be implemented by any suitable device(s). The method may be implemented by hardware, software, and/or firmware of the computing device 102, and/or another computing device.

With continuing reference to FIG. 2, the method includes detecting 200 a change in movement of the computing device 102 to substantially zero velocity for a predetermined period of time is provided. The computing device 102 is configured to detect the change of movement using the accelerometer 120 for a period of time using the processor 114.

The method of FIG. 2 includes detecting 202 a predetermined orientation of the computing device. Continuing the example, the computing device 102 is configured to detect a predetermined orientation of the computing device 102. As described above, the computing device 102 uses the accelerometer 120 and/or an optional GPS 118 to determine the orientation of the computing device 102.

The method of FIG. 2 includes initiating 204 a predetermined operation of the computing device in response to detecting the decrease in movement for the predetermined period of time and detecting the predetermined orientation of the computing device. Continuing the aforementioned example, the computing device 102 can initiate a predetermined operation of the computing device 102 in response to detecting the decrease in movement for the predetermined period of time and detecting the predetermined orientation of the computing device 102. As described above, the predetermined operation may be a set of computer-readable instructions or other executable application including a web browser for internet access via the network interface 104.

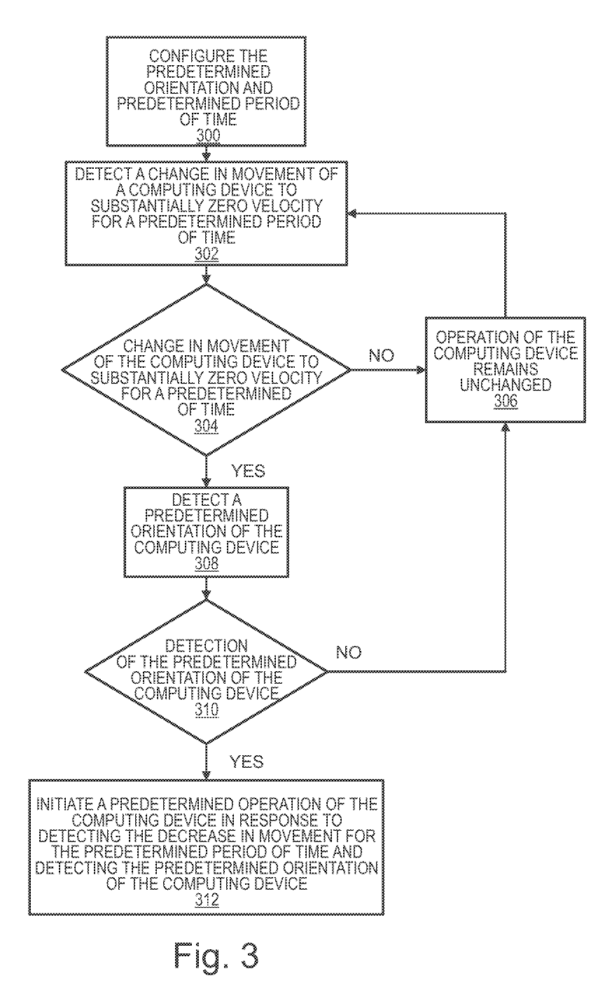

FIG. 3 is a flowchart showing further detail of an exemplary method of detecting a change in movement of the computing device 102 to substantially zero velocity for a predetermined period of time, detecting a predetermined orientation of the computing device 102 and initiating a predetermined operation of the computing device 102. The method of FIG. 3 includes an additional step of configuring or adjusting the predetermined movement, orientation, period of time or operation in block 300. The predetermined thresholds (e.g., movement, orientation, time or operation) may be configured through the network interface 104, the barcode scanner 110, the keyboard displayed on the display 108, or other inputs, such as, buttons, switches or dials (not shown). For example, the retail personnel may use the user interface 106 (e.g., a touchscreen display, keyboard, and/or mouse) to also configure the predetermined thresholds. The predetermined thresholds may also be defined or set via a configuration file. This file could be a simple editable text file, or be built by a configuration program. Once built, the file could be installed on every device using traditional software tools (e.g., at install, remotely, etc.). The computing device 102 may control the user interface 106 for providing an interface for the user to set the predetermined thresholds. Subsequent to predetermined threshold information being entered, the information may be stored in the memory 112 of the computing device 102. Different customizations may be allowed based on user identification information. For example, certain retail personnel of different authorizations may be allowed to set predetermined thresholds that those of lower positions cannot set. In an example, retail personnel may be allowed to set a personal screensaver or screen background that can be enabled after the retail personnel has reached a certain level of performance.

In continuing reference to FIG. 3, the method includes detecting 302 a change in movement of a computing device to substantially zero velocity for a predetermined period of time. As described above the threshold for substantially zero velocity and the predetermined period of time are configurable parameters. If the computing device 102 detects no change in movement of the computing device 102, the processor 114 may initiate a timer for the predetermined period of time (block 304) as defined above. As a non-limiting example, the predetermined period of time may be a few milliseconds to a few seconds or more. If a change of movement of the computing device 102 is detected, the operation of the computing device remains unchanged and the timer in the processor 114 is reset (block 306). If no change of the movement of the computing device 102 is detected for the predetermined period of time, the method may determine the orientation of the computing device and detects whether the computing device 102 is at a predetermined orientation (block 308). If the computing device 102 is at a predetermined orientation (block 310) or within a predetermined orientation range (e.g., 45° to 50° angle) the computing device 102 can initiate a predetermined operation of the computing device in response (block 312), otherwise the operation of the computing device 102 remains unchanged and the timer is reset (block 306). It should be noted that the predetermined orientation may be defined in any direction of rotation, whether front to back, side to side or any combination or manner of rotation possible for the computing device 102.

In accordance with embodiments of the present invention, the computing device 102 may change the operation between a work mode and a user-selected feature mode. For example, in a work mode, the computing device 102 may operate for conducting purchase transactions. In a user-selected mode, the computing device 102 may display or permit user-selected features. Further, the computing device 102 may determine a predetermined operation of the computing device 102 such as, for example, that the computing device 102 being used for conducting a purchase transaction. In response to determining the predetermined operation, the computing device 102 may disable the user-set operation. In another example, an operator of the computing device 102 may interact with the user interface 106 for instructing the computing device 102 to switch between the work and user-selected operation modes.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
detecting a change in movement of a computing device to substantially zero velocity for a predetermined period of time;
detecting a predetermined orientation of the computing device; and
initiating a predetermined operation of the computing device in response to detecting the decrease in movement for the predetermined period of time and detecting the predetermined orientation of the computing device.

2. The method of claim 1, further comprising configuring the predetermined period of time.

3. The method of claim 2, wherein configuring the predetermined period of time comprises receiving user input for configuring the predetermined period of time.

4. The method of claim 1, wherein initiating the predetermined operation comprises displaying a keyboard on a display of the computing device.

5. The method of claim 1, wherein initiating the predetermined operation comprises triggering execution of a set of computer-readable instructions for implementation by the computing device.

6. The method of claim 1, further comprising configuring the predetermined orientation of the computing device.

7. The method of claim 6, wherein configuring the predetermined orientation comprises receiving user input for configuring the predetermined orientation.

8. A system comprising:
a computing device comprising at least a processor and memory, wherein the computing device is configured to:
detect a change in movement of a computing device to substantially zero for a predetermined period of time;
detect a predetermined orientation of the computing device; and
initiate a predetermined operation of the computing device in response to detecting the decrease in movement for the predetermined period of time and detecting the predetermined orientation of the computing device.

9. The system of claim 8, further comprising configuring the predetermined period of time.

10. The system of claim 9, wherein configuring the predetermined period of time comprises receiving user input for configuring the predetermined period of time.

11. The system of claim 8, wherein the predetermined operation comprises displaying a keyboard on a display of the computing device.

12. The system of claim 8, wherein the predetermined operation comprises triggering execution of a set of computer-readable instructions for implementation by the computing device.

13. The system of claim 8, further comprising configuring the predetermined orientation of the computing device.

14. The system of claim 13, wherein configuring the predetermined orientation comprises receiving user input for configuring the predetermined orientation.

15. A computer program product comprising a computer readable storage medium having program instructions embodied therewith, the program instructions executable by a computing device to cause the computing device to:
detect, by the computing device, a decrease in movement to zero velocity by an computing device for a predetermined period of time;
detect, by the computing device, a predetermined orientation of the computing device; and
initiate, by the computing device, a predefined action in response to detecting a decrease in movement to zero velocity by an electronic device for a predetermined period of time and detecting a predetermined orientation of the computing device.

16. The computer program product of claim 15, wherein the program instructions are executable by the computing device to cause the computing device to configure the predetermined period of time.

17. The computer program product of claim 16, wherein the program instructions are executable by the computing device to cause the computing device to configure the predetermined period of time comprising receiving user input for configuring the predetermined period of time.

18. The computer program product of claim 15, wherein the program instructions are executable by the computing device to cause the computing device to initiate the predetermined operation comprising displaying a keyboard on a display of the computing device.

19. The computer program product of claim 15, wherein the program instructions are executable by the computing device to cause the computing device to initiate the predetermined operation comprising triggering execution of a set of computer-readable instructions for implementation by the computing device.

20. The computer program product of claim 15, wherein the program instructions are executable by the computing device to cause the computing device to configure the predetermined orientation of the computing device.

21. The computer program product of claim 20, wherein the program instructions are executable by the computing device to cause the computing device to configure the predetermined orientation comprising receiving user input for configuring the predetermined orientation.
